(19) United States
(12) Patent Application Publication
(10) Pub. No.: US 2019/0110475 A1
(43) Pub. Date: Apr. 18, 2019

(54) ATTRACTANTS FOR MICE

(71) Applicant: Gerhard GRIES, Coquitlam (CA)

(72) Inventors: Gerhard Gries, Coquitlam (CA); Antonia Musso, Burnaby (CA); Regine Gries, Coquitlam (CA); Huimin Zhai, Burnaby (CA); Stephen J. Takacs, Hope (CA)

(21) Appl. No.: 16/095,070

(22) PCT Filed: Apr. 21, 2017
(86) PCT No.: PCT/CA2017/050498

§ 371 Date: Oct. 19, 2018

Related U.S. Application Data
(60) Provisional application No. 62/325,616, filed on Apr. 21, 2016.

(51) Int. Cl. A01N 43/78; A01N 25/00; A01N 43/28; A01M 23/16; A01M 25/00; A01M 23/14; A01M 23/36; A01M 23/30

(52) U.S. Cl. CPC A01N 43/78; A01N 25/004; A01N 43/28; A01M 23/16; A01M 2200/00; A01M 23/14; A01M 23/36; A01M 23/30; A01M 25/002

(57) ABSTRACT

Compositions attractive to mice include one or more additives. The additives can include 2-sec-butyl-4,5-dihydrothiazole and/or 3,4-dehydro-ero-brevicomin, which can be isolated, purified and/or synthetic. In addition to these additives, the compositions can also include a lethal agent, such as, an anticoagulant or a toxicant, a chemostenlant and/or food. Devices and methods of using the composition are also disclosed.

### REFERENCE TO RELATED APPLICATIONS

The present application claims the priority benefit of U.S. provisional application Ser. No. 62/325,616, entitled ATTRACTANTS FOR MICE, filed Apr. 21, 2016, and hereby incorporates the same application herein by reference in its entirety.

### TECHNICAL FIELD

The present disclosure generally relates to compositions, devices, and methods for attracting mice.

### BACKGROUND

House mice are global pests. They cause damage by soiling food, spreading allergens, diminishing yields of agricultural crops, serving as reservoirs for disease-causing pathogens, endangering island seabird colonies, and by acting as an invasive species harming indigenous fauna (Wanless et al. 2007, Angel et al. 2009). These many adverse effects have prompted ongoing efforts to trap and poison mice. However, mice can exhibit neophobia (the fear of new objects) (Brigham & Sibley 1999). The lag time for neophobic rodents to become conditioned to the presence of newly placed traps, or trap boxes containing snap traps, and to enter them greatly reduces the effectiveness of mouse control efforts.

### SUMMARY

According to one embodiment, a composition for attracting a mouse includes one or more additives. The one or more additives include 2-sec-butyl-4,5-dihydrothiazole, 3,4-dehydro-exo-brevicomin, or a combination thereof. The one or more additives are isolated, purified, synthetic, or a combination thereof.

According to another embodiment, a device for attracting a mouse includes a housing or a trap and a composition adjacent to, or included within, the housing or the trap. The composition includes one or more additives. The one or more additives include 2-sec-butyl-4,5-dihydrothiazole, 3,4-dehydro-exo-brevicomin, or a combination thereof. The one or more additives are isolated, purified, synthetic, or a combination thereof.

According to another embodiment, a device for attracting a mouse includes a housing for receiving a mouse and a composition adjacent to, or included within, the housing. The composition includes one or more additives. The one or more additives include 2-sec-butyl-4,5-dihydrothiazole, 3,4-dehydro-exo-brevicomin, or a combination thereof. The one or more additives are isolated, purified, synthetic, or a combination thereof.

According to another embodiment, a device for attracting a mouse includes a trap for trapping a mouse and a composition adjacent to, or included within, the trap. The composition includes one or more additives. The one or more additives include 2-sec-butyl-4,5-dihydrothiazole, 3,4-dehydro-exo-brevicomin, or a combination thereof. The one or more additives are isolated, purified, synthetic, or a combination thereof.

According to another embodiment, a method for attracting a mouse includes providing a composition. The composition includes one or more additives. The one or more additives include 2-sec-butyl-4,5-dihydrothiazole, 3,4-dehydro-exo-brevicomin, or a combination thereof. The one or more additives are isolated, purified, synthetic, or a combination thereof.

### BRIEF DESCRIPTION OF THE DRAWINGS

FIG. 1 depicts a graph illustrating the total ion chromatograms of volatile components emanating from urine- and feces-soiled bedding material of adult male house mice and adult female house mice.

FIG. 2 depicts an illustration of an experimental design for behavioral experiments.

FIG. 3 depicts a graph showing the effect of the synthetic 2-component house mouse volatile blend (3,4-dehydro-exo-brevicomin (“DEB”) and 2-sec-butyl-4,5-dihydrothiazole (“DHT”) at a 1:1 ratio; 2 mg total; formulated in 10 g of mineral oil) on behavioral responses of house mouse females in Experiment 1.

FIG. 4 depicts an illustration of an additional experimental design for behavioral experiments.

FIG. 5 depicts a graph showing the effect of the synthetic 2-component house mouse volatile blend on trap captures of adult and juvenile male and female house mice in Experiment 2.

FIG. 6 depicts an example of a device according to one embodiment.

FIG. 7 depicts an example of a device according to another embodiment.

FIG. 8 depicts an example of a device according to another embodiment.

FIG. 9 depicts an example of a device according to another embodiment.

FIG. 10 depicts an example of a device according to another embodiment.

FIG. 11 depicts an example of a device according to another embodiment.

FIG. 12 depicts an example of a device according to another embodiment.

FIG. 13 depicts an example of a device according to another embodiment.

### DETAILED DESCRIPTION

The term “isolated” as used herein means separated from materials with which the compound is normally associated in a native state.

The term “purified” as used herein refers to material that has been isolated under conditions that reduce, or eliminate, the presence of unrelated materials, i.e., contaminants, including native materials from which the material is obtained. Purified material, substantially free of contaminants, can be 50% or more pure; 90% or more pure, or 99% or more pure. Purity can be evaluated by methods known in the art.

The term “synthetic” as used herein means artificially produced by chemical processes or other processes initiated by human energy, as opposed to compounds formed by natural processes.

The term “lethal” as used herein means sufficient to result in immobilization, knockdown and/or death of 50% or more, 55% or more, 60% or more, 65% or more, 70% or more, 75% or more, 80% or more, 85% or more, 90% or more, 95% or more, or 99% or more, mice.

The term “lethal agent” as used herein means an agent that is capable of immobilizing, knocking down, and/or killing 50% or more, 55% or more, 60% or more, 65% or more, 70% or more, 75% or more, 80% or more, 85% or more, 90% or more, 95% or more, or 99% or more, mice that are exposed to an appropriate dose, number or intensity over an appropriate amount of time.

The term “chemosterilant” as used herein means a substance that is capable of sterilizing 50% or more, 55% or more, 60% or more, 65% or more, 70% or more, 75% or more, 80% or more, 85% or more, 90% or more, 95% or more, or 99% or more, mice that are exposed to an appropriate dose, number or intensity of the substance over an appropriate amount of time.

The term “mouse” as used herein refers to at least one mouse of the genus Mus, including the house mouse (Mus musculus).

The term “attractant” as used herein refers to any composition or formulation that makes attractive to a mouse or mice, a habitat, food source or other site which may be frequented or traversed by a mouse or mice.

Certain embodiments of the present disclosure relate to a composition for attracting at least one mouse. In certain embodiments, the composition can include one or more additives. For example, in certain embodiments, the one or more additives can include 3,4-dehydro-exo-brevicomin (“DEB”) and/or 2-sec-butyl-4,5-dihydrothiazole (“DBT”). In certain embodiments, the compositions described herein can include one or two of the additives. The additive can be isolated, purified, and/or synthetic in various embodiments.

In certain embodiments, the one or more additives can include optical isomers. For example, suitable additives can include (1R,5S,7R)-3,4-dehydro-exo-brevicomin, (1S,5R,7S)-3,4-dehydro-exo-brevicomin, (S)-2-(sec-butyl)-4,5-dihydrothiazole, (R)-2-(sec-butyl)-4,5-dihydrothiazole, or mixtures thereof.

In certain embodiments, the composition includes one or more additives, wherein the one or more additives include 3,4-dehydro-exo-brevicomin and/or 2-sec-butyl-4,5-dihydrothiazole.

In certain embodiments, the composition includes one or more additives, wherein the one or more additives include 3,4-dehydro-exo-brevicomin and/or 2-sec-butyl-4,5-dihydrothiazole, and the composition is useful for attracting mice. In certain embodiments, the compositions can attract female mice.

In certain embodiments, the composition includes one or more isolated additives and one or more lethal agent(s) and chemosterilant(s).

In embodiments including a lethal agent, the lethal agent can be a chemical that is capable of causing immobilization and/or death of one or more mice. For example, the chemical can be one or more of an anticoagulant and/or a toxicant. In certain embodiments, examples of suitable lethal agents can include warfarin ((RS)-4-hydroxy-3-(3-oxo-1-phenylbutyl)-2H-chromen-2-one), chlorophacinone (2-[2-(4-chlorophenyl)-1-oxo-2-phenylethyl]indane-1,3-dione), diphacinone (2-(diphenylacetyl)-1H-indene-1,3(2H)-dione), bromadiolone (3-[3-[4-(4-bromophenyl)phenyl]-3-hydroxy-1-phenylpropyl]-2-hydroxychromen-4-one), difethialone (3-[3-[4-(4-bromophenyl)phenyl]-1-tetralinyl]-2hydroxy-4-thiochromenone), brodofacoum (3-[3-[4-(4-bromophenyl)phenyl]-1,2,3,4-tetrahydronaphthalen-1-yl]-2-hydroxychromen-4-one), and combinations thereof. In certain embodiments, suitable toxicants can include bromethalin (N-methyl-2,4-dinitro-6-(trifluoromethyl)-N-(2′,4′,6′-tribromophenyl)aniline), cholecalciferol ((3β,5Z,7E)-9,10-secocholesta-5,7,10-(19)-trien-3-ol), zinc phosphide (zinc phosphide/trizinc diphosphide), strychnine (strychnidin-10-one), and combinations thereof.

In embodiments including a chemosterilant, the chemosterilant can be a chemical that is capable of sterilizing one or more mice. For example, suitable chemosterilant chemicals that can sterilize female mice can include mestranol, quinoestrol, diethylstilbestrol, methyl testosterone, the 3-cyclopentyl ester of 17α-hexa-1′3′-diynyloestra-1,3,5(10)-trien-17β-ol, α-chlorhydrin, and 4-vinylcyclohexene diepoxide.

In certain embodiments, the described compositions can further include a food bait. Suitable food baits can include natural foodstuffs such as meat, cheese, eggs, and/or grains. For example, a food bait can include lard and cracklings, cereal flour (e.g., oat flour and/or rice flour), cereal bran (e.g., wheat bran), gelling agent(s) (e.g., gelatin and/or agar), sugar (e.g., fructose), oil(s) (e.g., safflower oil), emulsifier(s) (e.g., soy lecithin) and humectant(s) (e.g., carrageenan gum powder), water, chemical attractants (e.g., 2-hydroxy-3-methylcyclopent-2-en-1-one, 2,3-butadione, 3-methylbutanal, 5-methyl-(E)-2-hepten-4-one, 5-methyl-4-heptanone, γ-octalactone and/or butyric acid), and combinations thereof.

In certain embodiments, the compositions described herein can be used to attract one or more mice. The composition can be used as a bait, and, can optionally be included in a trap. In certain embodiments, a composition consisting essentially of one or more additives can be used to attract one or more mice. In certain embodiments, a composition including one or more additives, and optionally other components, can be used to attract one or more mice. For example, a composition consisting of one or two additives can be used to attract one or more mice. The additive can be isolated, purified, and/or synthetic.

In certain embodiments, a composition including one or more additives in an amount of about 1% to about 99% of the composition can be used to attract one or more mice. For example, the one or more additives can be included in an amount of about 1% or more, about 2% or more, about 5% or more, about 7.5% or more, about 10% or more, about 12.5% or more, about 15% or more, about 17.5% or more, about 20% or more, about 22.5% or more, about 25% or more, about 27.5% or more, about 30% or more, about 32.5% or more, about 35% or more, about 37.5% or more, about 40% or more, about 42.5% or more, about 45% or more, about 47.5% or more, about 50% or more, about 52.5% or more, about 55% or more, about 57.5% or more, about 60% or more, about 62.5% or more, about 65% or more, about 67.5% or more, about 70% or more, about 72.5% or more, about 75% or more, about 77.5% or more, about 80% or more, about 82.5% or more, about 85% or more, about 87.5% or more, about 90% or more, about 92.5% or more, about 95% or more, about 97.5% or more, and about 99% or more, by weight of the composition.

In certain embodiments, the one or more additives can be included in an amount of about 1% or less, about 2% or less, about 5% or less, about 7.5% or less, about 10% or less, about 12.5% or less, about 15% or less, about 17.5% or less, about 20% or less, about 22.5% or less, about 25% or less, about 27.5% or less, about 30% or less, about 32.5% or less, about 35% or less, about 37.5% or less, about 40% or less, about 42.5% or less, about 45% or less, about 47.5% or less, about 50% or less, about 52.5% or less, about 55% or less, about 57.5% or less, about 60% or less, about 62.5% or less, about 65% or less, about 67.5% or less, about 70% or less, about 72.5% or less, about 75% or less, about 77.5% or less, about 80% or less, about 82.5% or less, about 85% or less, about 87.5% or less, about 90% or less, about 92.5% or less, about 95% or less, about 97.5% or less, and about 99% or less, by weight of the composition. The composition can be used as a bait, and can optionally be included in a trap. The additive can be isolated, purified, and/or synthetic.

In certain embodiments, the composition can also include at least one lethal agent in an amount of about 1% to about 99% of the composition. The lethal agent can be a chemical that is capable of immobilizing or killing one or more mice. In certain embodiments, the lethal agent(s) can be included in an amount of about 1% or more, about 2% or more, about 5% or more, about 7.5% or more, about 10% or more, about 12.5% or more, about 15% or more, about 17.5% or more, about 20% or more, about 22.5% or more, about 25% or more, about 27.5% or more, about 30% or more, about 32.5% or more, about 35% or more, about 37.5% or more, about 40% or more, about 42.5% or more, about 45% or more, about 47.5% or more, about 50% or more, about 52.5% or more, about 55% or more, about 57.5% or more, about 60% or more, about 62.5% or more, about 65% or more, about 67.5% or more, about 70% or more, about 72.5% or more, about 75% or more, about 77.5% or more, about 80% or more, about 82.5% or more, about 85% or more, about 87.5% or more, about 90% or more, about 92.5% or more, about 95% or more, about 97.5% or more, and about 99% or more, by weight of the composition.

In certain embodiments, the lethal agent(s) can be included in an amount of about 1% or less, about 2% or less, about 5% or less, about 7.5% or less, about 10% or less, about 12.5% or less, about 15% or less, about 17.5% or less, about 20% or less, about 22.5% or less, about 25% or less, about 27.5% or less, about 30% or less, about 32.5% or less, about 35% or less, about 37.5% or less, about 40% or less, about 42.5% or less, about 45% or less, about 47.5% or less, about 50% or less, about 52.5% or less, about 55% or less, about 57.5% or less, about 60% or less, about 62.5% or less, about 65% or less, about 67.5% or less, about 70% or less, about 72.5% or less, about 75% or less, about 77.5% or less, about 80% or less, about 82.5% or less, about 85% or less, about 87.5% or less, about 90% or less, about 92.5% or less, about 95% or less, about 97.5% or less, and about 99% or less, by weight of the composition.

In certain embodiments, the composition can also, or alternatively, include one or more chemosterilants in an amount of about 1% to about 99% of the composition. The chemosterilant(s) can be a chemical that is capable of sterilizing one or more mice. In certain embodiments, the chemosterilant(s) can be effective to sterilize female mice. In certain embodiments, the chemosterilant(s) can be included in an amount of about 1% or more, about 2% or more, about 5% or more, about 7.5% or more, about 10% or more, about 12.5% or more, about 15% or more, about 17.5% or more, about 20% or more, about 22.5% or more, about 25% or more, about 27.5% or more, about 30% or more, about 32.5% or more, about 35% or more, about 37.5% or more, about 40% or more, about 42.5% or more, about 45% or more, about 47.5% or more, about 50% or more, about 52.5% or more, about 55% or more, about 57.5% or more, about 60% or more, about 62.5% or more, about 65% or more, about 67.5% or more, about 70% or more, about 72.5% or more, about 75% or more, about 77.5% or more, about 80% or more, about 82.5% or more, about 85% or more, about 87.5% or more, about 90% or more, about 92.5% or more, about 95% or more, about 97.5% or more, and about 99% or more, by weight of the composition.

In certain embodiments, the chemosterilant(s) can be included in an amount of about 1% or less, about 2% or less, about 5% or less, about 7.5% or less, about 10% or less, about 12.5% or less, about 15% or less, about 17.5% or less, about 20% or less, about 22.5% or less, about 25% or less, about 27.5% or less, about 30% or less, about 32.5% or less, about 35% or less, about 37.5% or less, about 40% or less, about 42.5% or less, about 45% or less, about 47.5% or less, about 50% or less, about 52.5% or less, about 55% or less, about 57.5% or less, about 60% or less, about 62.5% or less, about 65% or less, about 67.5% or less, about 70% or less, about 72.5% or less, about 75% or less, about 77.5% or less, about 80% or less, about 82.5% or less, about 85% or less, about 87.5% or less, about 90% or less, about 92.5% or less, about 95% or less, about 97.5% or less, and about 99% or less, by weight of the composition.

In certain embodiments, any of the compositions described herein can include no more than two additives. Alternatively, in certain embodiments, any of the compositions described herein can include two or more additives. The additives can be isolated, purified, and/or synthetic.

In certain embodiments, any of the compositions described herein can consist essentially of no more than two additives. In certain embodiments, any of the compositions described herein consists essentially of at least two additives. The additive can be isolated, purified, and/or synthetic.

In certain embodiments, any of the compositions described herein can consist of no more than two additives. The additive can be isolated, purified, and/or synthetic.

In certain embodiments, the composition can consist essentially of no more than two additives and a lethal agent. In certain embodiments, any of the compositions described herein can include two or more additives and a lethal agent. The additives can be isolated, purified, and/or synthetic.

In certain embodiments, a composition can consist essentially of no more than two additives and a chemosterilant. In certain embodiments, any of the compositions described herein can include two or more additives and a chemosterilant. The additives can be isolated, purified, and/or synthetic.

In certain embodiments described herein, a composition that attracts one or more mice can be formulated as a granule, a solid block, a gel, a powder, a paste, a liquid, or as combinations thereof.

As can be appreciated, any of the compositions described herein can be included in a device for attracting one or more mice. The device can include a composition including one or more additives and, optionally, one or more of a lethal agent and a chemosterilant. In certain embodiments, the device can include a housing for receiving at least one mouse. The composition can include one or more additives and, optionally, one or more of a lethal agent and a chemosterilant. The composition can be adjacent to, or included, within the housing. The housing can also include a food bait that is adjacent to, or included within, the composition. The housing can allow a mouse to enter and leave the device after ingesting the composition. The housing can be configured so that a mouse can enter the device, but other animals are less likely to be able to enter the device. For example, the housing can contain a size-restrictive entryway, and the housing can optionally include a sharp turn. The device can be reusable (e.g., be rebaitable) or can be a single-use device.

The device can also include, or alternatively be, a trap. The trap can be an immobilizing trap (e.g., a sticky trap or a chamber trap), an impaling trap, a snap trap, an asphyxiation trap (e.g., a drowning trap, or a noose-based trap), an electrocution trap, a skull-fracturing piston trap, a catch-and-release trap, a self-resetting trap capable of multiple killings, or combinations thereof.

As can be appreciated, the device can trap, or kill, more than one mouse in certain embodiments. For example, a device for attracting one or more mice can include multiple single-use traps, a plurality of chambers that can each trap one mouse, or a single chamber that can trap or kill multiple mice in various embodiments.

Other variations to the device are also possible in certain embodiments. For example, a device can automatically kill and remove a mouse in certain examples. In such examples, a mouse can be lured into a trap housing that kills the mouse using, for example, an impaling trap, a compression trap, an asphyxiation trap, an electrocution trap, or a skull-fracturing piston trap. Once the mouse has been killed, the trap can reset itself releasing the mouse to fall out of both the trap housing and device. As can be appreciated, such devices can kill multiple mice without human intervention. In certain embodiments, such devices can be mechanically powered (using e.g., a compressed gas cartridge) or can be electrically powered.

As can be appreciated, other devices are also possible in certain embodiments. For example, in certain embodiments, a device for attracting mice can be a dispensing device or a dispersing device which dispenses, or disperses, a composition as described herein. As can be appreciated, the composition in such embodiments can be an aerosolized liquid or the like.

In certain embodiments, a device can include a housing for receiving a mouse, as well as a composition comprising one or more additives. Referring to FIG. 6, a device according to one embodiment is disclosed. Device (100) can include a housing (110). The housing (110) can include composition (120), which includes additive (130). In certain embodiment, the housing (110) can also include at least one food bait. In certain embodiments, the housing (110) can also include a trap. The composition (120) can be included within, or adjacent to, the trap within housing (110).

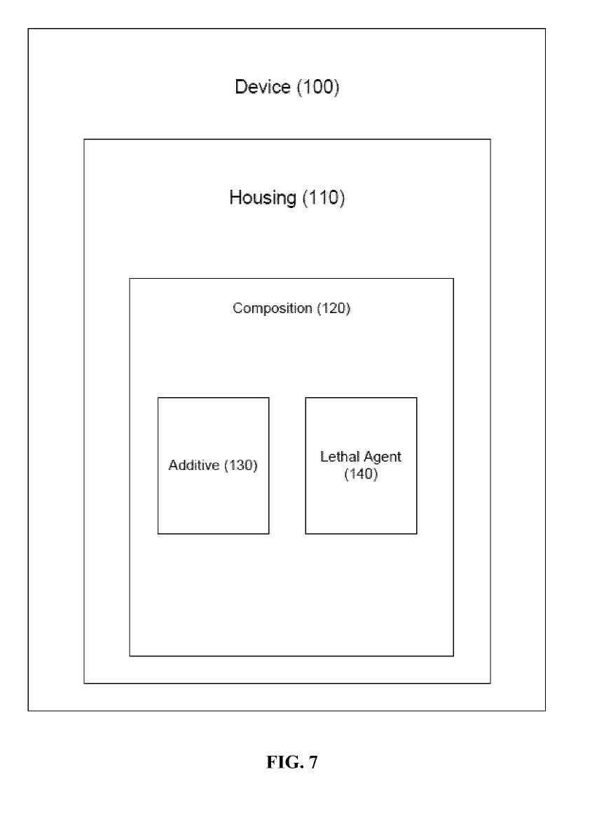

Referring to FIG. 7, a device according to an embodiment is disclosed. Device (100) can include a housing (110). The housing (110) can include composition (120), which includes additive (130) and lethal agent (140). In certain embodiments, housing (110) can also include at least one food bait. In certain embodiments, housing (110) can also include a trap. The composition (120) can be included within, or adjacent to, the trap within housing (110).

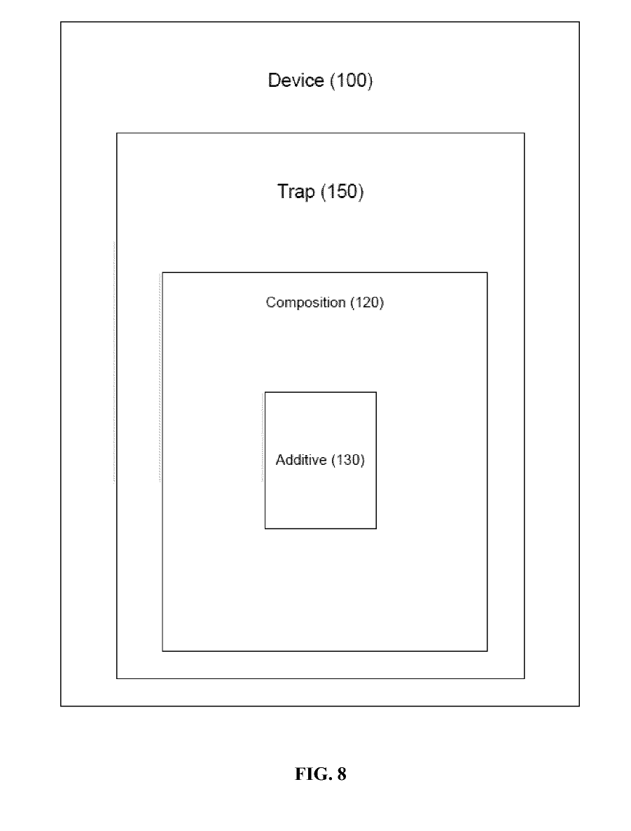

Referring to FIG. 8, a device according to an embodiment is disclosed. Device (100) can include trap (150). The trap (150) can include composition (120), which includes additive (130). In certain embodiments, the trap (150) can also include at least one food bait. In certain embodiments, trap (150) can also include a housing. The composition (120) can be included within or adjacent to the housing within trap (150).

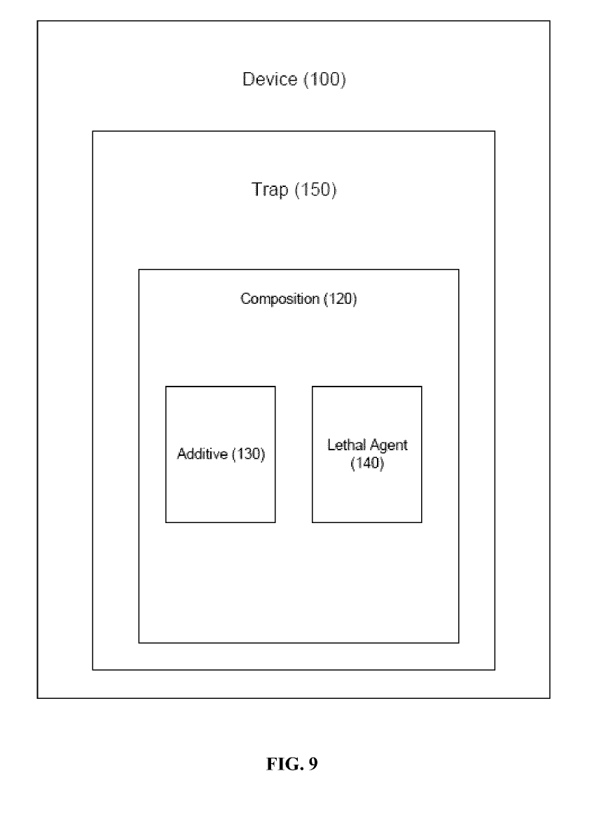

Referring to FIG. 9, a device according to an embodiment is disclosed. Device (100) can include trap (150). The trap (150) can include composition (120), which includes additive (130) and lethal agent (140). In certain embodiments, trap (150) can also include at least one food bait. In certain embodiments, trap (150) can also include a housing. The composition (120) can be included within, or adjacent to, the housing within trap (150).

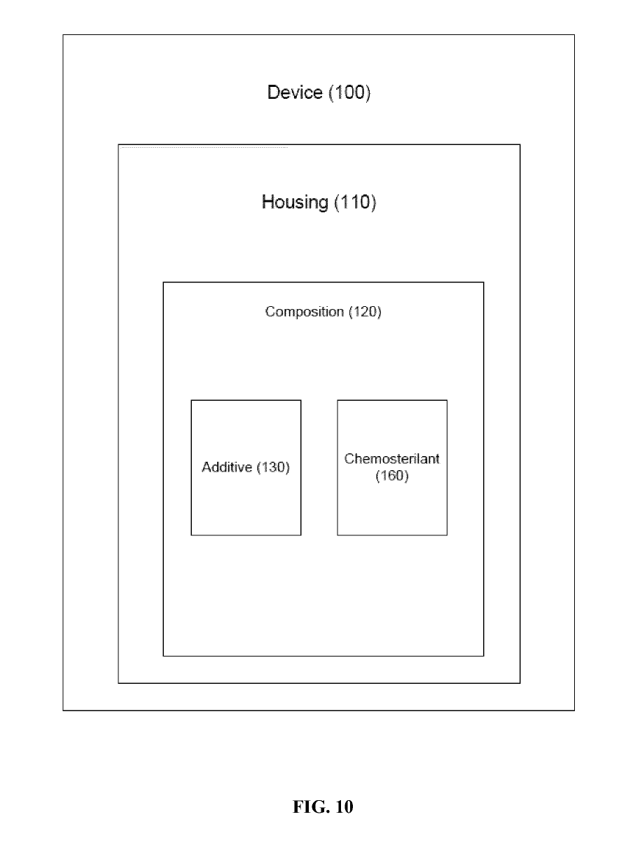

Referring to FIG. 10, a device according to an embodiment is disclosed. Device (100) can include housing (110). The housing (110) can include composition (120), which includes additive (130) and chemosterilant (160). In certain embodiments, the housing (110) can also include at least one food bait. In certain embodiments, the housing (110) can also include a trap. The composition (120) can be included within, or adjacent to, the trap within housing (110).

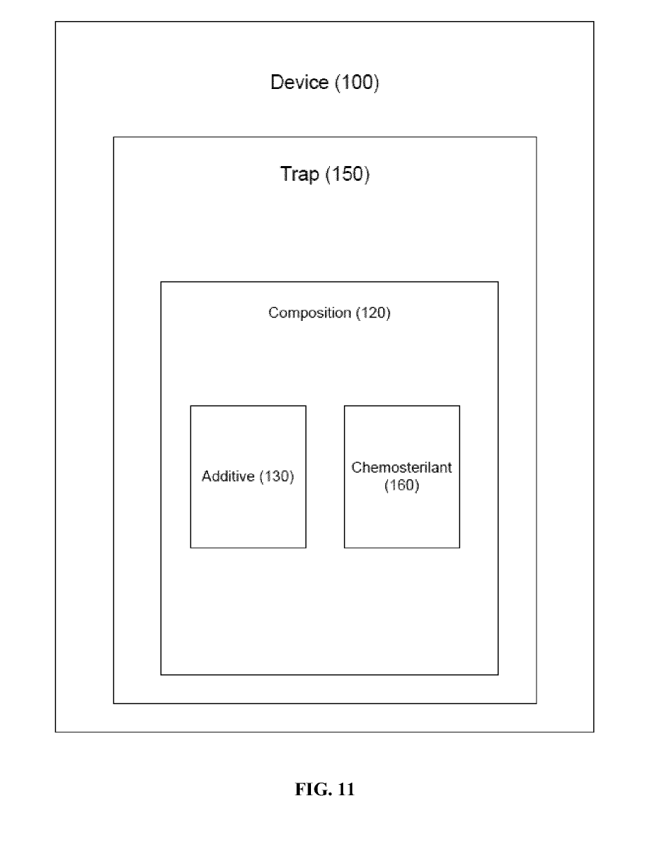

Referring to FIG. 11, a device according to an embodiment is disclosed. Device (100) can include trap (150). The trap (150) can include composition (120), which includes additive (130) and chemosterilant (160). In certain embodiments, trap (150) can also include at least one food bait. In certain embodiments, trap (150) can also include a housing. The composition (120) can be included within, or adjacent to, the housing within trap (150).

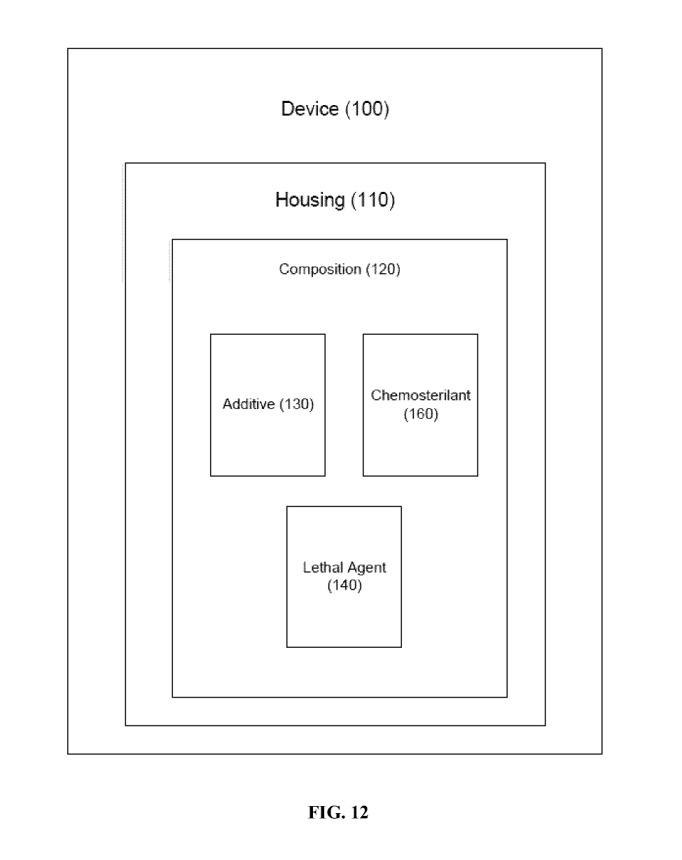

Referring to FIG. 12, a device according to an embodiment is disclosed. Device (100) can include housing (110). The housing (110) can include composition (120), which includes additive (130), lethal agent (140), and chemosterilant (160). In certain embodiments, the housing (110) can also include at least one food bait. In certain embodiments, the housing (110) can also include a trap. The composition (120) can be included within, or adjacent to, the trap within housing (110).

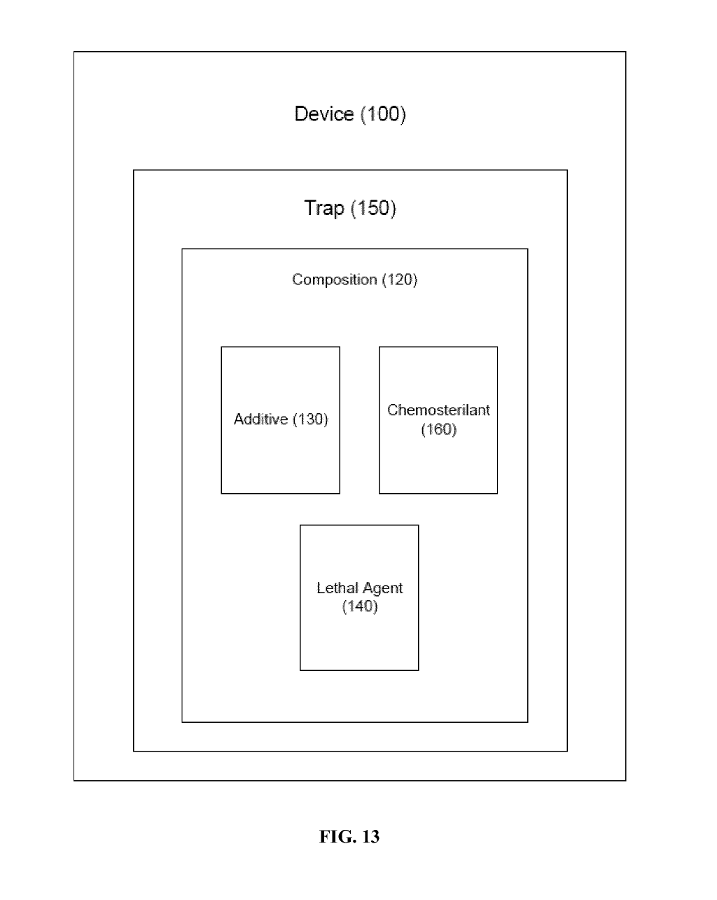

Referring to FIG. 13, a device according to an embodiment is disclosed. Device (100) can include trap (150). The trap (150) can include composition (120), which includes additive (130), lethal agent (140), and chemosterilant (160). In certain embodiments, the trap (150) can also include at least one food bait. In certain embodiments, the trap (150) can also include a housing. The composition (120) can be included within, or adjacent to, the housing within trap (150).

Any of the compositions described herein can be used to attract one or more mice. The one or more mice can be attracted by providing any of the compositions described herein. The one or more mice can also be immobilized and/or killed by providing any of the compositions described herein with a lethal agent. The one or more mice can also be sterilized by providing any of the compositions described herein with a chemosterilant. The composition can be provided in a dose that can be sufficient to result in the attraction, and optionally, the sterilization and/or immobilization and/or death of one or more mice.

### EXAMPLES

### Source and Maintenance of the Mouse Colony

House mice, Mus musculus (strain: CD-1; UACC protocol number 1159B-15), were obtained from Charles River Laboratories Ltd (Sherbrooke, Québec J1E 0B5, Canada) and housed in the Animal Research Centre of Simon Fraser University (“SFU”). On arrival, mice were assigned to four groups of five male mice each and four groups of five female mice each, accommodated in cages (50 cm×40 cm×20 cm) lined with commercial corn cob bedding (Anderson's Bed o'cobs, The Andersons Inc. Maumee, Ohio 43537, USA), provided with Nalgene toys, running wheels (Jaimesons Pet Food Distributers, Richmond, BC V4G 1C9, Canada), and provisioned with commercial rodent food (LabDiet® Certified Rodent Diet, LabDiet, St Louis, Mo. 64144, USA) as well as water ad libitum.

### Capture of Headspace Odorants from Urine- and Feces-Soiled Bedding of Male or Female House Mice

Urine- and feces-stained bedding was removed and replaced with fresh bedding at weekly intervals. Soiled bedding (100 g) from male mice and female mice were placed into separate cylindrical Pyrex glass chambers, each connected to a Pyrex glass tube (15 cm×5 mm OD) filled with 200 mg of the absorbent Porapak Q. Charcoal-filtered air was drawn through each chamber and the Porapak Q volatile trap at 1 liter per min for 24 h. Processing clean bedding from a control cage without mice in the same way helped differentiate between bedding and rodent volatiles in subsequent analyses. Porapak Q-captured volatiles were desorbed with two consecutive rinses of pentane (2 ml) and ether (2 ml). Pentane and ether extracts were combined and, after adding dodecyl acetate as an internal standard for compound quantification, were concentrated under a stream of nitrogen to 250 μl per sample.

### Analyses of Porapak Q Headspace Volatile Extract of Soiled-Bedding Odorants from Male and Female Mice by Gas Chromatography-Mass Spectrometry (GC-MS)

Aliquots (2 μl) of Porapak Q extracts of soiled bedding odorants from male house mice and female house mice were analyzed on a Varian Ion Trap GC-MS fitted with a DB-5 MS GC column (30 m×0.25 mm ID), setting the injector port and ion trap to 250° C. and using helium as the carrier gas at a flow of 35 cm per sec, with the following temperature program: 50° C. for 5 min, 10° C. per min until 280° C. (10 min). Odorants were identified by comparing their retention indices (relative to straight chain alkanes) and mass spectra with those reported in the literature and with those of authentic standards that were available from previous work, purchased from suppliers (Sigma Aldrich Company, St. Louis, Mo. 63103, USA; Aldrich Chemical Company Inc., Milwaukee, Wis. 53201, USA; Alfa Aesar, Heysham, LA3 2XY England), or synthesized (2-sec-butyl-4,5-dihydrothiazole and 3,4-dehydro-exo-brevicomin).

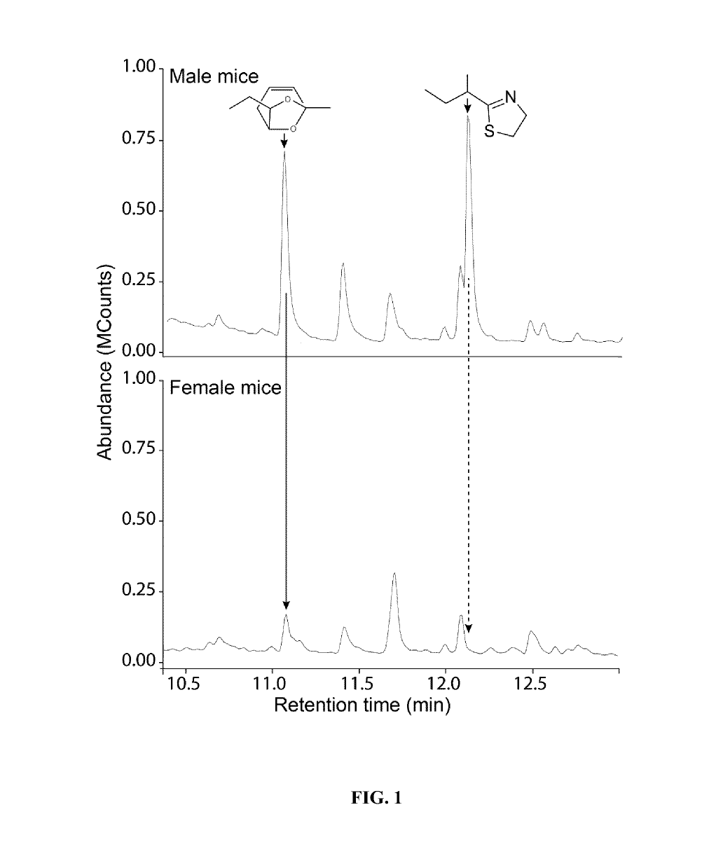

The analyses are depicted in FIG. 1 and revealed complex odor blends emanating from soiled bedding of male mice and female mice.

Many volatile compounds were common in Porapak Q headspace volatile extracts of bedding soiled by mice of either sex, but 2-sec-butyl-4,5-dihydrothiazole was found only in the bedding of male house mice and 3,4-dehydro-exo-7-ethyl-5-methyl-6.8-dioxabicyclo[3.2.1]octane (3,4-dehydro-exo-brevicomin) was found to be 7 times more prevalent in headspace volatiles of male house mice bedding as depicted in FIG. 1. These two compounds together had been previously classed as a primer pheromone because they reportedly induce estrous and decrease the age at which female house mice reach sexual maturity (Jemiolo et al. 1986). However, they were not known to have any behavioral function, which would allow them also to be classed as a releaser pheromone.

### Example 1

### Test for Behavioral Function of 2-Component Composition

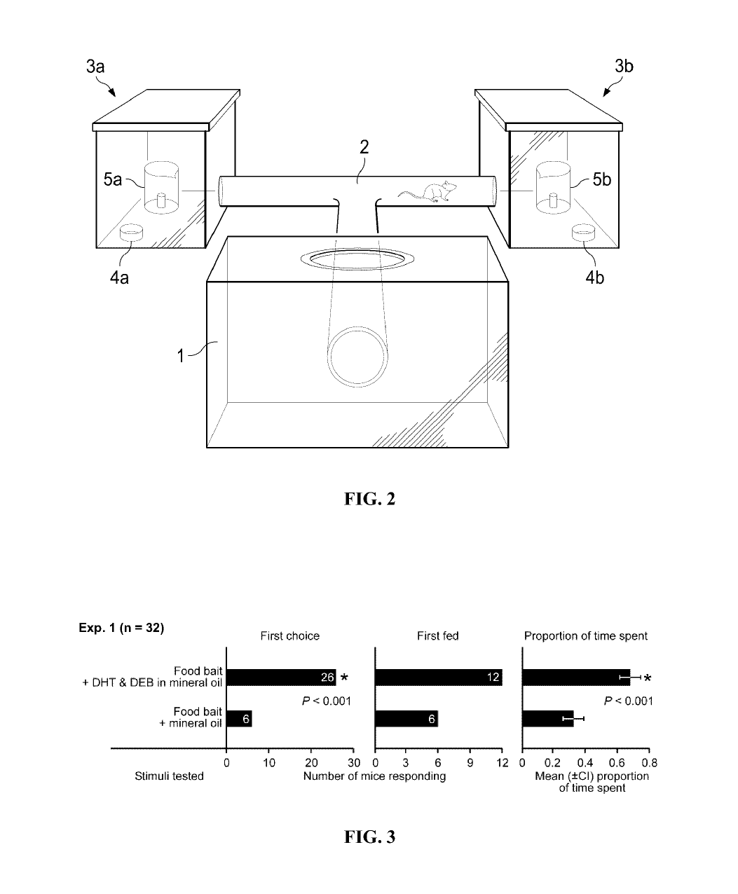

The olfactometer, illustrated in FIG. 2, for Experiment 1 consisted of three clear Plexiglas chambers (1: 40 cm×20 cm×30 cm; 3a and 3b: each 60 cm×30 cm×40 cm) interconnected by a Pyrex glass T-tube (2; stem: 65 cm long, side arms: 45 cm long, all 10 cm in diameter). For each replicate, a single mouse was deprived of food, but not water, for 4-6 h before being placed into chamber 1 which was illuminated by dim red light to facilitate observations of the mouse's position. The mouse was allowed to enter the stem of the T-tube (2) on its own accord in response to test stimuli, which were randomly assigned to chamber 3a or 3b.

FIG. 2 depicts the olfactometer used in Experiment 1. The olfactometer includes a T-tube design used to test behavioral responses of house mice, Mus musculus, to test stimuli in Experiment 1. The design includes: (1) a release chamber (aquarium: L×W×H; 40×20×30 cm) for placement of a mouse at the onset of a bioassay; (2) a T-tube (stem: 65 cm long, side arms: 45 cm long, all 10 cm in diameter); (3a, 3b) stimulus chambers (aquaria: each 60×30×40 cm) housing test stimuli; (4) Petri dish with food bait; and (5) a scintillation vial (2.8 cm×5.75 cm) containing 10 g of mineral oil that was laced, or not, with the synthetic 2-component male house mouse pheromone.

For Experiment 1, both chambers of the olfactometer were baited with 1 g of a cereal-based food bait (Musso et al. 2014) in a Petri dish (4; 3 cm diameter). The treatment stimulus also comprised 2 mg of a 1:1 blend of two compounds (2-sec-butyl-4,5-dihydrothiazole and 3,4-dehydro-exo-brevicomin) (each >98% chemically pure), which were formulated in 10 g of mineral oil and pipetted into a 20-ml scintillation vial (5a; Wheaton Industries Inc., Millville, N.J. 08332, USA). A control scintillation vial (5b) contained the same amount of mineral oil but lacked the two volatile compounds. Each scintillation vial was placed in a 150-ml beaker (6a, 6b), which was covered with wire mesh (Phifer Inc., Tuscaloosa, Ala., 35403-1700, USA) to prevent mice from contacting the vial or its contents.

For each bioassay, a single mouse was tested and the following data were recorded: 1) the treatment or control chamber the mouse entered first with all four paws (“first choice data”), 2) the chamber in which it first fed on the food bait (“first-feeding data”), and 3) the position of the mouse at each of 40 15-sec intervals. Position data were then used to calculate the proportion of time a mouse spent in the treatment or control chamber (“time spent data”).

Following each replicate, the chambers and T-tube were cleaned with a Percept® disinfectant detergent (Virox Technologies Inc. Mississaugua ON L5N 5M4, Canada) and wiped with 70% ethanol.

Experiment 1 tested the effect of the synthetic two-component blend on the response of female mice.

For Experiment 1, first-choice data and first-feeding data were analyzed using a Chi-square test with Yate's correction for continuity (α=0.05). Time-spent data measurements were analyzed by comparing the mean proportions of time points recorded in control and treatment arenas, using a t-test (α=0.05).

In Experiment 1, female house mice (n=32) more often entered first the treatment arena containing the blend of 2-sec-butyl-4,5-dihydrothiazole and 3,4-dehydro-exo-brevicomin than the control arena as depicted in FIG. 3 (χ²=11.28; P<0.001), but they did not feed first more often in the treatment arena than in the control arena (χ²=1.39; P>0.05).

Additionally in Experiment 1, female house mice spent twice as much time in the treatment arena containing the blend of 2-sec-butyl-4,5-dihydrothiazole and 3,4-dehydro-exo-brevicomin than in the control arena as further depicted in FIG. 3 (t=6.95, P<0.001).

The results of Experiment 1 suggest, surprisingly, that the two-component blend had a significant releaser pheromone effect on female house mice influencing both their first choice of arena to enter and where the female house mice spent most of their time during the bioassays. Despite the positive data obtained with laboratory-strain female house mice, it was considered essential to obtain definitive field data prior to reaching any conclusion as to whether the blend functions as a releaser pheromone under natural conditions.

### Example 2

### Responses of Wild House Mice to the Synthetic Two-Component Blend in a Field Experiment

Experiment 2 was run in the field from Jan. 22, 2015 to Sep. 25, 2015, and evaluated the effect of the synthetic two-component blend on trap captures of wild mice. Experimental replicates were set up along the interior walls of a retirement home, a floral conservatory, and a horse barn, and along the exterior walls of a poultry barn, all in the Lower Mainland of British Columbia. Each replicate (N=72) consisted of paired trap boxes (PROTECTA® Mouse, Bell Laboratories Inc., Madison, Wis. 53704, USA) each armed with a snap trap (Victor® M325 M7 Pro mouse trap, Woodstream Co. Lititz, Pa. 175543, USA), with 50-cm spacing between boxes in each pair, and at least 2 m between pairs.

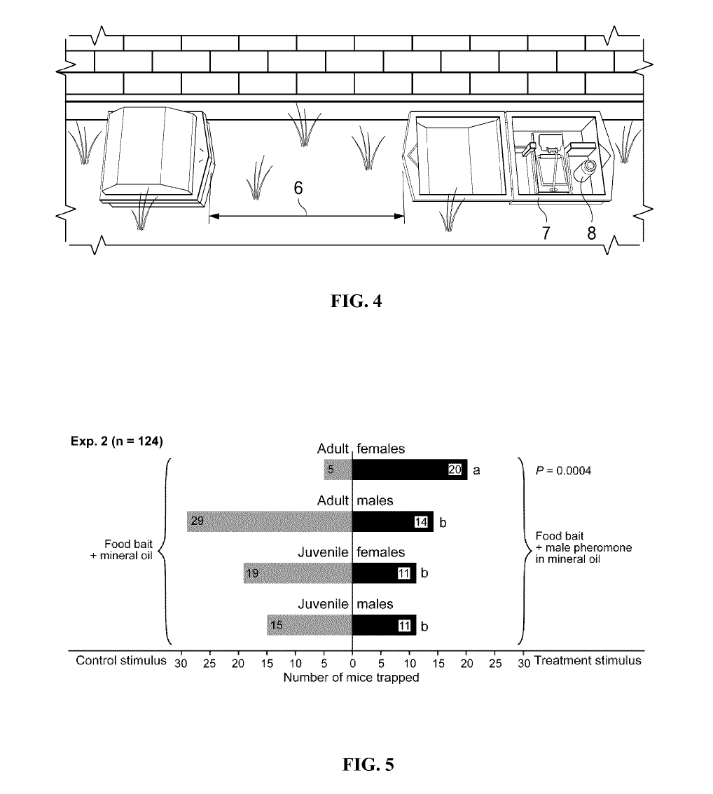

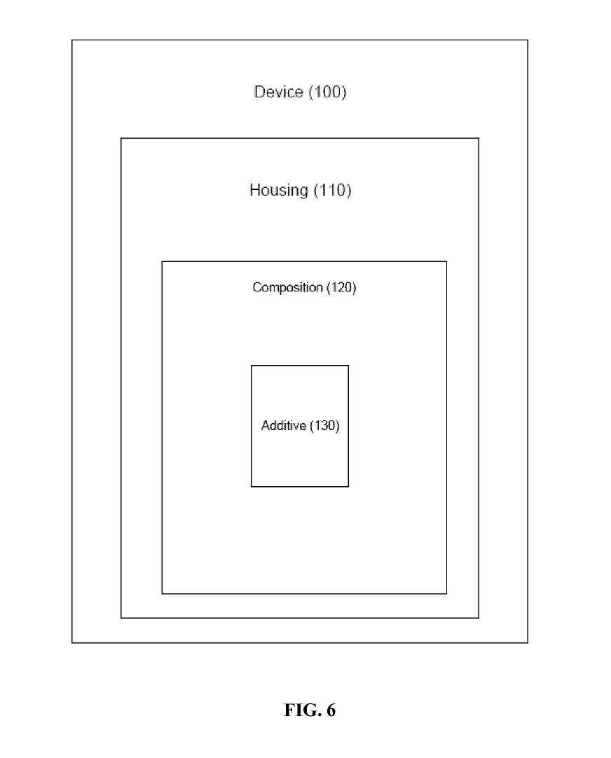

The experimental setup of one of 72 experimental replicates of paired trap boxes (6) deployed along the interior or exterior walls of buildings utilized in Experiment 2 is depicted in FIG. 4. Each setup included 50-cm spacings between the respective trap boxes (6) in each pair, and at least 5 m between pairs of trap boxes. Each box (6) contained a snap trap (7) that was baited with a food bait and fitted with a custom-designed scintillation vial (8; 2.1 cm×4 cm) containing 10 g of mineral oil that was laced, or not, with synthetic male house mouse pheromone (2 mg) utilized in Experiment 1.

All boxes and snap traps were checked every 48 h to 72 h, and test stimuli (food lure, male house mouse pheromone blend in mineral oil, and mineral oil) were replaced at each visit. Whenever mice had been captured, their age (juvenile or adult) and sex were recorded, and new trap boxes and snap traps were deployed, thus ensuring that the odor of captured mice did not affect future captures.

Capture data of mice in treatment and control traps were analyzed using a logistic regression performed in R (v. 3,4,3, Urbanek & Bibiko; R Development Core Team 20150) and plotted separately for adult female mice, adult male mice, juvenile female mice, and juvenile male mice. The probabilities of trapping mice in these four groups were analyzed by multiple comparisons using the Tukey method.

In Experiment 2, snap traps in treatment boxes baited with the two-component blend captured 20 adult female house mice, whereas snap traps in control boxes captured only 5 adult females as depicted in FIG. 5. Conversely, snap traps in treatment boxes baited with the two-component blend captured only 14 adult male house mice, whereas snap traps in control boxes captured 29 adult male house mice. Captures of juvenile mice in treatment and control boxes were similar.

Logistic regression analyses of trapping data revealed significant differences (residual deviance=7.71 P=0.0004) based on the age/sex group of mice [adult females, adult males, juvenile females or juvenile males]. Multiple comparisons of trapping probabilities further indicated that the two-component blend had a significant effect (Tukey; P−0.05). The probability of an adult female mouse being captured in a treated trap relative to the control was 0.8 whereas the similar probabilities for adult males, juvenile females, or juvenile males were 0.33, 0.37, and 0.42, respectively.

The results of Experiment 2 constitute unexpected evidence that the two-component blend of 2-sec-butyl-4,5-dihydrothiazole and 3,4-dehydro-exo-brevicomin attract adult females, and could potentially be used to improve their captures in traps baited with a food bait or their ingestion of a food bait laced with a lethal or chemosterilant substance. These field data strongly support the conclusion that the synthetic, two-component blend of 2-sec-butyl-4,5-dihydrothiazole and 3,4-dehydro-exo-brevicomin can be classed as a releaser pheromone that mediates the behavior of adult female house mice.

The following documents are hereby incorporated by reference in their entireties: Angel, A., R. M. Wanless, and J. Cooper. 2009. Review of impacts of the introduced house mouse on islands in the Southern Ocean: are mice equivalent to rats? Biological Invasions 11:1743-1754; Brigham, A. J. and R. M. Sibly. 1999. A review of the phenomenon of neophobia. In Cowan, D. P., Feare, C. J. (Eds): Advances in vertebrate pest management. Filander, Verlag, Furth, Germany; Jemiolo, B., S. Harvey, and M. Novotny. 1986. Promotion of the Whitten effect in female mice by synthetic analogs of male urinary constituents. Proceedings of the National Academy of Sciences 83: 4576-4579; Musso, A. E., S. J. Takacs, R. M. Gries and G. J. Gries. 2014. New compositions and methods for attracting and stimulating feeding by mice and rats. Patent Cooperation Treaty Patent Application Publication No. WO 2014/186885; Wanless, R. M., A. Angel, R. J. Cuthbert, G. M. Hilton, and P. G. Ryan. 2007. Can predation by invasive mice drive seabird extinctions? Biology letters 3:241-244.

As used herein, all percentages (%) are percent by weight of the total composition, also expressed as weight/weight %, % (w/w), w/w, w/w % or simply %, unless otherwise indicated. Also, as used herein, the terms “wet” refers to relative percentages of the coating composition in a dispersion medium (e.g. water); and “dry” refers to the relative percentages of the dry coating composition prior to the addition of the dispersion medium. In other words, the dry percentages are those present without taking the dispersion medium into account. Wet admixture refers to the coating composition with the dispersion medium added. “Wet weight percentage”, or the like, is the weight in a wet mixture; and “dry weight percentage”, or the like, is the weight percentage in a dry composition without the dispersion medium. Unless otherwise indicated, percentages (%) used herein are dry weight percentages based on the weight of the total composition.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather, it is hereby intended the scope be defined by the claims appended hereto.

1. A composition for attracting a mouse comprising:
one or more additives comprising 2-sec-butyl-4,5-dihydrothiazole, 3,4-dehydro-exo-brevicomin, or a combination thereof; and
wherein the one or more additives are isolated, purified, synthetic, or a combination thereof.

2. The composition of claim 1, further comprising a lethal agent.

3. The composition of claim 2 comprises a dose of the lethal agent sufficient to kill or immobilize a mouse.

4. The composition of claim 2, wherein the lethal agent comprises a chemical capable of killing or immobilizing a mouse.

5. The composition of claim 4, wherein the chemical comprises one or more of an anticoagulant and a toxicant.

6. The composition of claim 5, wherein the anticoagulant comprises one or more of warfarin ((RS)-4-hydroxy-3-(3-oxo-1-phenylbutyl)-2H-chromen-2-one), chlorophacinone (2-[2-(4-chlorophenyl)-1-oxo-2-phenylethyl]indane-1,3-dione), diphacinone (2-(diphenyl acetyl)-1H-indene-1,3(2H)-dione), bromadiolone (3-[3-[4-(4-bromophenyl)phenyl]-3-hydroxy-1-phenylpropyl]-2-hydroxychromen-4-one), difethialone (3-[3-[4-(4-bromophenyl)phenyl]-1-tetralinyl]-2-hydroxy-4-thiochromenone), and brodifacoum (3-[3-[4-(4-bromophenyl)phenyl]-1,2,3,4-tetrahydronaphthalen-1-yl]-2-hydroxychromen-4-one).

7. The composition of claim 5, wherein the toxicant comprises one or more of bromethalin (N-methyl-2,4-dinitro-6-(trifluoromethyl)-N-(2′,4′,6′-tribromophenyl)aniline), cholecalciferol ((3β,5Z,7E)-9,10-secocholesta-5,7,10(19)-trien-3-ol), zinc phosphide (zinc phosphide/trizinc diphosphide), and strychnine (strychnidin-10-one).

8. The composition of claim 1, further comprising a chemosterilant.

9. The composition of claim 8, wherein the chemosterilant comprises one or more of mestranol, quinoestrol, diethylstilbestrol, methyl testosterone, 3-cyclopentyl ester of 17α-hexa-1′3′-diynyloestra-1,3,5(10)-trien-17β-ol, α-chlorhydrin, and 4-vinylcyclohexene diepoxide.

10. The composition of claim 1, wherein the one or more additives are isolated.

11. The composition of claim 1, wherein the one or more additives are synthetic.

12. The composition of claim 1, wherein the one or more additives are purified.

13. The composition of claim 1 is a granule, a powder, a solid block, a gel, a paste, a liquid, or a combination thereof.

14. The composition of claim 1 further comprising a food bait.

15. The composition of claim 14, wherein the food bait comprises one or more of meat, cheese, eggs, nuts, bacon, and one or more grains.

16. The composition of claim 14, wherein the food bait comprises one or more of lard and cracklings, cereal flour, cereal bran, gelling agent, sugar, oil, emulsifier, a humectant, and water.

17. The composition of claim 1, wherein the one or more additives comprise 2-sec-butyl-4,5-dihydrothiazole and 3,4-dehydro-exo-brevicomin.

18. The composition of claim 1 attracts at least one female mouse.

19. A device for attracting a mouse comprising:
a housing or a trap; and
the composition of claim 1; and
wherein the one or more additives are isolated, purified, synthetic, or a combination thereof; and
wherein the composition is adjacent to, or included within, the housing or the trap.

20. The device of claim 19 comprises the housing, wherein the housing is configured to receive at least one mouse.

21. The device of claim 20, wherein the housing is sized for a house mouse.

22. The device of claim 19 comprises the trap.

23. The device of claim 22, wherein the trap comprises one or more of an immobilizing trap, an impaling trap, a snap trap, an asphyxiation trap, an electrocution trap, a catch-and-release trap, and a skull-fracturing piston trap.

24. The device of claim 22, wherein the trap comprises a self-resetting trap capable of multiple killings.

25-59. (canceled)
